(19) United States
(12) Patent Application Publication
(10) Pub. No.: US 2024/0219358 A1
(43) Pub. Date: Jul. 4, 2024

(54) BIOMARKERS ASSOCIATED WITH RESIDUAL FEED INTAKE OF CHICKENS IN GROWING PERIOD AND APPLICATION THEREOF

(71) Applicants: Shandong Agricultural University, Taian City (CN); Shandong Center for Quality Control of Feed and Veterinary Drug, Jinan City (CN); Shandong Hemeihua Nongmu Co., Ltd, Jinan City (CN)

(72) Inventors: Xianyao LI, Taian City (CN); Meng LIANG, Jinan City (CN); Qingwei ZHANG, Taian City (CN); Jiming LIU, Jinan City (CN); Liying LIU, Taian City (CN); Youzhi LI, Jinan City (CN); Baishun MA, Jinan City (CN); Yanan ZHAO, Taian City (CN); Yuanmei WANG, Taian City (CN)

(73) Assignees: Shandong Agricultural University, Taian City (CN); Shandong Ceter for Quality Control of Feed and Veterinary Drug, Jinan City (CN); Shandong Hemeihua Nongmu Co., Ltd, Jinan City (CN)

(21) Appl. No.: 18/399,803

(22) Filed: Dec. 29, 2023

(30) Foreign Application Priority Data
Dec. 30, 2022 (CN) 2022117247519

(51) Int. Cl. G01N 30/72; A01K 45/00; G01N 30/02; G01N 30/88

(52) U.S. Cl. CPC G01N 30/72; A01K 45/00; G01N 30/88; G01N 2030/027; G01N 2030/884

(57) ABSTRACT

The invention discloses biomarkers associated with residual feed intake of growing chickens in growing period and application thereof, which belongs to the field of poultry breeding technology. These biomarkers include one or multiple components of 13(S)-HOTrE, 20-carboxy-LTB4, Traumatic acid, 15-deoxy-delta-12,14-PGJ2, LysoPC(20:2(11Z,14Z)), phosphorycholine, Sphingosine, malic acid, D-4′-Phosphopantothenate, and Spermidine. The invented biomarkers can realize the identification of the residual feed intake, which has high sensitivity and specificity, and is expected to become a new method for the identification of the residual feed intake.

### TECHNICAL FIELD

The invention relates to the field of poultry breeding technology, and specifically relates to biomarkers associated with residual feed intake of chickens in growing period and application thereof.

### BACKGROUND ART

Residual feed intake (RFI) is an important index to evaluate feed efficiency. RFI refers to the difference between the actual feed intake of livestock or poultry and the expected feed intake for maintenance and growth needs obtained by regression, which has moderate heritability. The cost of feed accounts for 60-70% of the total cost of breeding, with the rising price of feed raw materials, the cost of feed is gradually increasing. Breeding low RFI livestock and poultry is conducive to improving feed utilization and reducing feeding costs.

The breeding of the residual feed intake of the broiler chickens can reduce the fat content and the feed intake, increase the muscle content, and improve the feed efficiency without affecting the growth of livestock and poultry. However, the calculation method of the residual feed intake makes it difficult to measure in actual production, it not only requires more manpower and material resources but also limits the selection of individuals or populations in breeding work to a certain extent.

Changes in individual metabolic characteristics can reflect the response of animal organisms to environmental stimulation or changes, linking metabolites to biological phenotypes, and providing the possibility for the discovery of new biomarkers. Blood is an important carrier of metabolites, the changes in blood metabolic characteristics can partly reflect the changes in animal feed efficiency, and there may be markers indicating feed efficiency in blood biochemical indexes. Therefore, it is of great significance to understand the relationship between animal blood biochemical indexes and residual feed intake for the breeding of feed efficiency. However, the biomarkers related to the residual feed intake of chickens in growing period have not been reported.

### SUMMARY OF THE INVENTION

In view of the above existing technology, the purpose of the invention is to provide biomarkers associated with residual feed intake of chickens in growing period and application thereof, the biomarkers of the invention can realize the identification of the residual feed intake, which has high sensitivity and specificity, and it is expected to become a new method for the residual feed intake identification.

In order to achieve the above purpose, the invention adopts the following technical solution:

The first aspect of the invention discloses biomarkers associated with residual feed intake of chickens in growing period, including one or multiple components of 13-(S)-hydroxyoctatrienoic acid (13(S)-HOTrE), 20-carboxy-leukotriene B4 (20-carboxy-LTB4), Traumatic acid, 15-deoxy-delta-12,14-prostaglandin J2 (15-deoxy-delta-12,14-PGJ2), lysophosphatidylcholine (20:2(11Z,14Z)) (LysoPC(20:2(11Z,14Z))), phosphorycholine, Sphingosine, malic acid, D-4′-Phosphopantothenate, and Spermidine.

Preferably, the biomarkers include an up-regulated marker combination and a down-regulated marker combination;
the up-regulated marker combination is composed of 13(S)-HOTrE, 20-carboxy-LTB4, Traumatic acid and 15-deoxy-delta-12,14-PGJ2;
the down-regulated marker combination is composed of LysoPC(20:2(11Z,14Z)), phosphorycholine, malic acid, D-4′-Phosphopantothenate, Sphingosine and Spermidine.

The second aspect of the invention discloses an usage of the above biomarker in a preparation of reagents or kits for identifying the residual feed intake of chickens in growing period.

In the above usage, the kits include a reagent combination for detecting the biomarker.

Preferably, the reagent combination includes a substance for detecting the biomarker by mass spectrometry.

The third aspect of the invention discloses an application of the above biomarkers as targets in a selective breeding of chickens with low residual feed intake.

The fourth aspect of the invention discloses a selective breeding method for chickens with low residual feed intake, the method includes steps of detecting the biomarkers in chicken serum by mass spectrometry.

Preferably, the biomarkers include an up-regulated marker combination and a down-regulated marker combination;
the up-regulated marker combination is composed of 13(S)-HOTrE, 20-carboxy-LTB4, Traumatic acid and 15-deoxy-delta-12,14-PGJ2;
the down-regulated marker combination is composed of LysoPC(20:2(11Z,14Z)), phosphorycholine, malic acid, D-4′-Phosphopantothenate, Sphingosine and Spermidine.

The beneficial effects of the invention are as follows:

For the first time, this invention discloses a plasma marker combination and its application that can be used for measuring the residual feed intake of chickens in growing period, it is found that the content of 13(S)-HOTrE, 20-carboxy-LTB4, Traumatic acid, 15-deoxy-delta-12,14-PGJ2, LysoPC (20:2(11Z,14Z)), Phosphocholine, Sphingosine, malic acid, D-4′-Phosphopantothenate, and Spermidine are significantly different in the plasma of the high residual feed intake group and the low residual feed intake group, the biomarkers are significantly correlated with residual feed intake, and are involved in the regulation of apoptosis, protein metabolism, lipid metabolism, energy metabolism, and immune response. They are potential biomarkers for identifying the residual feed intake. After the combinations of the up-regulated and down-regulated differential metabolites, the sensitivity and specificity of the identification of residual feed intake are significantly improved, the metabolomics technology can be used to identify the residual feed intake at the molecular level, it has the characteristics of high sensitivity and specificity, it is expected to become a new method for the identification of the residual feed intake.

### BRIEF DESCRIPTION OF DRAWINGS

FIG. 1 is a total ion chromatography of quality control samples; (A) is an ESI (+) total ion current diagram; (B) is an ESI (−) total ion current diagram.

FIG. 2 is a PCA score plot; (A) is a PCA score plot of the positive ion mode; (B) is a PCA score plot of the negative ion mode.

FIG. 3 is an OPLS-DA score plot; (A) is an OPLS-DA score plot of the positive ions; (B) is an OPLS-DA score plot of the negative ions.

FIG. 4 is an OPLS-DA permutation test diagram; (A) is an OPLS-DA permutation test diagram of the positive ions; (B) is an OPLS-DA permutation test diagram of the negative ions.

FIG. 5 is a volcano diagram of the differential metabolites; in the diagram, red dots represent significantly down-regulated differential metabolites, blue dots represent significantly up-regulated differential metabolites, gray dots represent metabolites with no significant difference, and the size of the scatter points represent the VIP value of the OPLS-DA model.

FIG. 6 is an up-regulated differential metabolite distribution box plot.

FIG. 7 is a down-regulated differential metabolite distribution box plot.

FIG. 8 is a ROC curve of the up-regulated metabolites.

FIG. 9 is a ROC curve of the up-regulated metabolite combination.

FIG. 10 is a ROC curve of the down-regulated metabolites.

FIG. 11 is a ROC curve of the down-regulated metabolite combination.

### DETAILED DESCRIPTION OF THE EMBODIMENTS

It should be noted that the following details are illustrative and are intended to provide further clarification of this application. Unless otherwise indicated, all technical and scientific terms used herein have the same meaning as those commonly understood by ordinary technicians in the field to which this application relates.

### Terms Description

Chickens in growing period: chickens of 7-20 wk of age.

In order to make the technical personnel in this field understand the technical solution of this application more clearly, the following will explain the technical solution of this application in detail with a specific embodiment.

The unspecified test materials used in the embodiment of the invention are all conventional test materials in this field, which can be purchased through commercial channels, the chickens used in the invention are AA+broiler chickens.

### Embodiment 1: Screening and Identification of the Biomarkers Related to the Residual Feed Intake of Chickens in Growing Period

### (1) Determination of the Residual Feed Intake and Sample Collection

A total of 125 hens of 15 wk of age with similar body weight are selected to measure the feed intake of chickens of 15-20 wk of age. The regression program of IBM SPSS Statistics 23 software and the following model are used to estimate the residual feed intake RFI of each chicken:

RFI=ADFI−(a+b×MBW+c×ADG)

Where a is the intercept, b, and c are partial regression coefficients, ADG is the average daily gain, MBW is the metabolic weight, and ADFI is the average daily feed intake.

By using the two-tailed method, 8 chickens with the highest residual feed intake are selected as the high residual feed intake group (HRFI group), and 8 chickens with the lowest residual feed intake are selected as the low residual feed intake group (LRFI group), the blood is collected from the vein under the wing, EDTA anticoagulant is added, the blood is centrifuged at 3,000 r/min for 10 min, and the upper plasma is separated and stored in a refrigerator at −80° C. for a long time.

### (2) Plasma Metabolome Sequencing

\textcircled{1} Sample pretreatment

Each plasma sample is taken for 200 μL plasma in an EP tube, 80 μL methanol and 400 L methyl tert-butyl ether (LMTBE) are added, vortexed, and mixed for 30 s, and ultrasonically extracted for 30 min (5° C., 40 KHz), the samples are placed at −20° C. for 30 min and then centrifuged at 13000 rmp (4° C.) for 15 min, 350 μL supernatant is removed, the remaining sample is dried in a vacuum concentrator, and then redissolved in 100 μL double solution (V_{isopropyl alcohol}:V_{acetonitrile}=1:1, volume ratio). After vortex mixing for 30 s, a 40 KHz ultrasound is carried out for the above product in an ice water bath for 5 min. after high-speed centrifuging (13000 rmp, 4° C.) for 5 min, 80 μL of the supernatant is transferred to an intubated vial for analysis. At the same time, all sample metabolites of equal volume are mixed to prepare the quality control samples (QC). In the process of instrumental analysis, one QC sample is inserted into every 6 samples and detected in the same batch as the samples to investigate the repeatability of the whole analysis process.

### \textcircled{2} LC-MS/MS Analysis

The instrument platform for LC-MS analysis is the ultra-high performance liquid chromatography tandem Fourier transform mass spectrometry UHPLC-Q Exactive HF-X system of Thermo Fisher Scientific.

Chromatographic conditions: after 2 μL sample is separated by BEH C18 chromatographic column ACQUITY UPLC HSS T3 (100 mm×2.1 mm i.d., 1.8 μm; Waters, Milford, USA), it is detected by mass spectrometry. Mobile phase A is 10 mM ammonium acetate-5% acetonitrile aqueous solution (Mobile phase A contained 0.1% formic acid in volume fraction), Mobile phase B is 2 mM ammonium acetate-47.5% acetonitrile-47.5% isopropanol-10% water (Mobile phase A contained 0.02% formic acid in volume fraction). The injection volume is 2 μL and the column temperature is 40° C. When the separation gradient is at 0-3.5 min, the linearity of Mobile phase A decreases from 100% to 75.5%, the linearity of Mobile phase B increases from 0% to 24.5%, and the flow rate is 0.40 mL/min; when the separation gradient is at 3.5-5 min, the linearity of Mobile phase A decreases from 75.5% to 35%, the linearity of Mobile phase B increases from 24.5% to 65%, the flow rate is 0.40 mL/min; when the separation gradient is at 5-5.5 min, the linearity of Mobile phase A decreases from 35% to 0%, the linearity of Mobile phase B increases from linear 65% to 100%, and the flow rate is 0.40 mL/min; when the separation gradient is at 5.5-7.4 min, the linearity of Mobile phase A maintains at 0%, the linearity of Mobile phase B maintains at 1000%, the flow rate is 0.60 mL/min; when the separation gradient is at 7.4-7.6 min, the linearity of Mobile phase A increases from 0% to 48.5%, the linearity of Mobile phase B decreases from 100% to 51.5%, the flow rate is 0.60 mL/min; when the separation gradient is at 7.6-7.8 min, the linearity of mobile phase A increases from 48.5% to 100%, the linearity of mobile phase B decreases from 51.5% to 0%, and the flow rate is 0.50 mL/min; when the separation gradient is at 7.8-10 min, the linearity of Mobile phase A linear maintains 100%, the linearity of Mobile phase B maintains 0%, the flow rate is 0.40 mL/min.

Mass spectrometry conditions: The samples are ionized by electrospray ionization, and the mass spectrometry signals are collected by positive and negative ion scanning modes, respectively. The mass scanning range is 70-1050 m/z. The ion spray voltage includes 3000 V positive ion voltage and −3000 V negative ion voltage, the S-Lens voltage is 50, the capillary temperature is 325° C., the sheath gas flow rate is 50 arb, the auxiliary gas flow rate is 13 arb, the ion source heating temperature is 425° C., the cycle collision energy is 20-60 V, the MSY resolution is 60000, the MS² resolution is 7500.

### (3) Data Preprocessing and Database Searching

After the tests are carried out in the above instrument, the LC-MS raw data are imported into the metabolomics processing software Progenesis QI (Waters Corporation, USA) for baseline filtering, peak identification, integration, retention time correction, peak alignment, identification, etc., finally, a data matrix containing retention time, mass-to-charge ratio and peak intensity is obtained. The data matrix uses 80% rules to remove the missing values, that is, to retain more than 80% variables with non-zero values in at least one set of samples, and then fill in the vacancy value (the minimum value in the original matrix fills in the vacancy value) to reduce the error caused by sample preparation and instrument instability, the response intensity of the sample mass spectrum peak is normalized by the sum normalization method, and the normalized data matrix is obtained. At the same time, the variables with relative standard deviation (RSD) >30% of QC samples are deleted, and the log 10 logarithmic processing is performed to obtain the final data matrix for subsequent analysis. The characteristic peaks of the data matrix are searched and identified, and the mass spectrometry information is matched with the database, the mass error is set to be less than 10 ppm, and the metabolites are identified according to the secondary mass spectrometry. The main databases for metabolite identification are HIMIDB (http://www.hmdb.ca/) and Metlin (https://metlin.scripps.edu/)) and self-built databases.

### (4) Metabolite Identification and Key Differential Metabolites Screening

Principal component analysis (PCA) is performed using the R software package ropls (Version 1.6.2), the principal component analysis is an unsupervised multivariate statistical analysis method, which recombines the original variables into several new unrelated comprehensive variables (i.e., principal components), all factors are ranked according to their importance, the smaller factors are usually ignored. By reducing the dimension, the data can be simplified, which can generally reflect the overall difference between the samples in each group and the degree of variation between the samples in the group. Orthogonal partial least squares discriminant analysis (OPLS-DA) is carried out, OPLS-DA is a combination of orthogonal signal correction (OSC) and PLS-DA, which can better distinguish the differences between groups and improve the effectiveness and analytical ability of the model. 7-fold cross validation is used to evaluate the stability of the model, the response permutation testing is used to randomly arrange the variables of the previously defined classification Y matrix 200 times by fixing the X matrix. After each permutation and combination, a new PLS or OPLS model is constructed, the cumulative R²Y and Q² values of the corresponding model are calculated, and then the original classification Y matrix and n different permutation Y matrix are linearly regressed with R²Y and Q², the intercept value of the regression line obtained and the y axis is used as the standard to measure whether the model is over-fitted, the intercept value is used to evaluate the accuracy of the PLS and OPLS models, and to perform Student's t test and difference multiple analysis. The variable weight value (VIP) >1 obtained by the OPLS-DA model and the P<0.05 of the student's t test are used as the screening criteria for significantly differential metabolites.

### (5) KEGG Analysis and Metabolic Pathway Analysis of Differential Lipid Metabolites in NSCLC

The KEGG database (https://www.kegg.jp/kegg/pathway.html)) is used to annotate the selected differential metabolites, and the Python software package scipy.stats is used for pathway enrichment analysis, the metabolic pathways are further screened by Fisher's exact test to obtain the biological pathways most related to the residual feed intake.

(6) ‘Gene-enzyme-reaction-metabolite’ network analysis of significantly differential metabolites

The fold change and P value of all NSCLC differential lipid metabolites are input into the MetScape plug-in of CytoScape (http://metscape.ncibi.org/) to obtain the total network of ‘gene-enzyme-biochemical reaction-metabolite’ and all sub-networks involved in differential metabolites.

### (7) Identification of Biomarkers Related to the Residual Feed Intake of Chickens in Growing Period

Based on the results of differential metabolite screening and metabolic pathway analysis, candidate biomarkers related to the residual feed intake of chickens in growing period are obtained. The ROC curve of the single index is drawn by the SPSS software for the candidate plasma differential biomarkers screened in this study, the sensitivity and specificity of the combined action of the indicators are calculated, and the diagnostic efficacy of the combined action of multiple indicators is analyzed to confirm the biomarkers related to the residual feed intake of chickens in growing period.

The results obtained by using the plasma biomarkers of the invention in the diagnosis of residual feed intake are as follows:

### (1) Overview of Metabolites

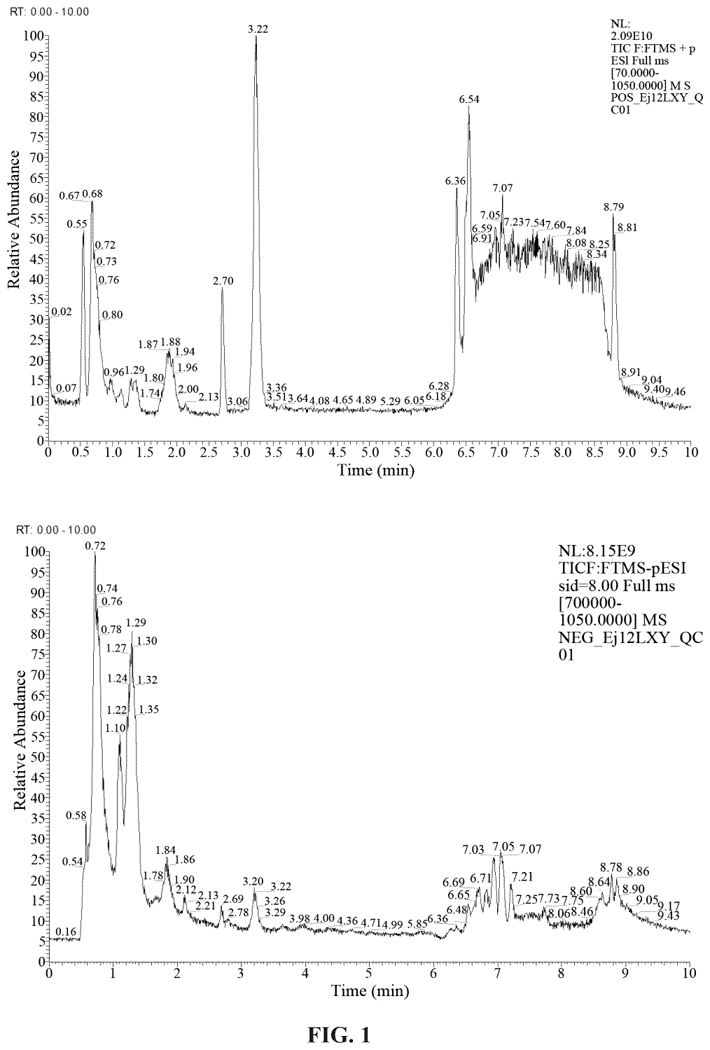

The total ion chromatogram of the quality control sample is shown in FIG. 1. The total ion chromatogram of the quality control sample in the positive and negative ion modes has a good peak shape and a relatively uniform distribution, indicating that the system is stable and the test data is reliable.

In positive and negative ion modes, 4084 and 4251 mass spectrum peaks are extracted after removing low mass ions according to relative standard deviation (RSD) >0.3. Through the primary and secondary mass spectrometry data, the database is finally annotated to 325 and 283 metabolites, mainly lipids, carbohydrates, vitamins, organic acids, and peptides.

### (2) UHPLC-Q Exactive HF-X/MS Data Analysis

### \textcircled{1} Multivariate Principal Component Analysis (PCA)

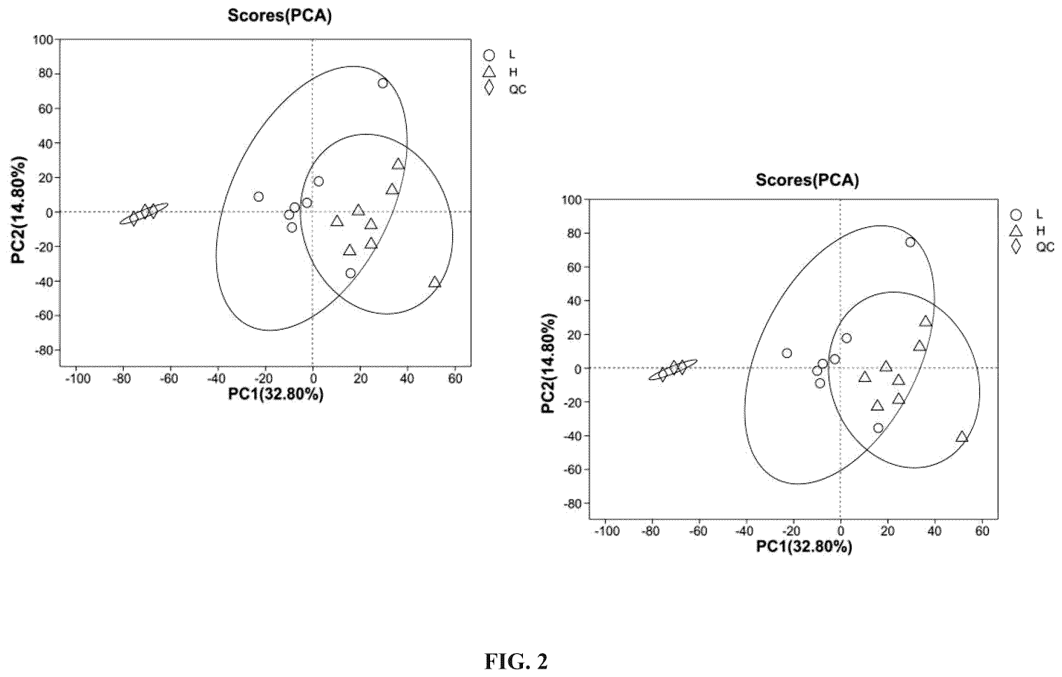

Principal component analysis can use mathematical methods to simplify the data, generally reflect the overall difference between the samples in each group and the degree of variation between the samples in the group, find out the outlier samples, and distinguish the sample clusters with high similarity. PCA modeling analysis is performed by using the R software package ropls (Version1. 6.2). In the positive ion mode and the negative ion mode, the PCA score plot (FIG. 2) shows that all samples are within the 95% confidence interval, significant separations are shown between the different residual feed intake groups in the positive ion mode, and no significant separation is shown in the negative ion mode. In the two modes, R²X (the interpretation rate of the model to the X matrix) is 0.581 and 0.578, respectively, both of which are greater than 0.5, and the quality control samples are clustered together in the two modes, indicating that the stability and repeatability of the system used in the test are high.

### \textcircled{2} Orthogonal Partial Least Squares Discriminant Analysis (OPLS-DA)

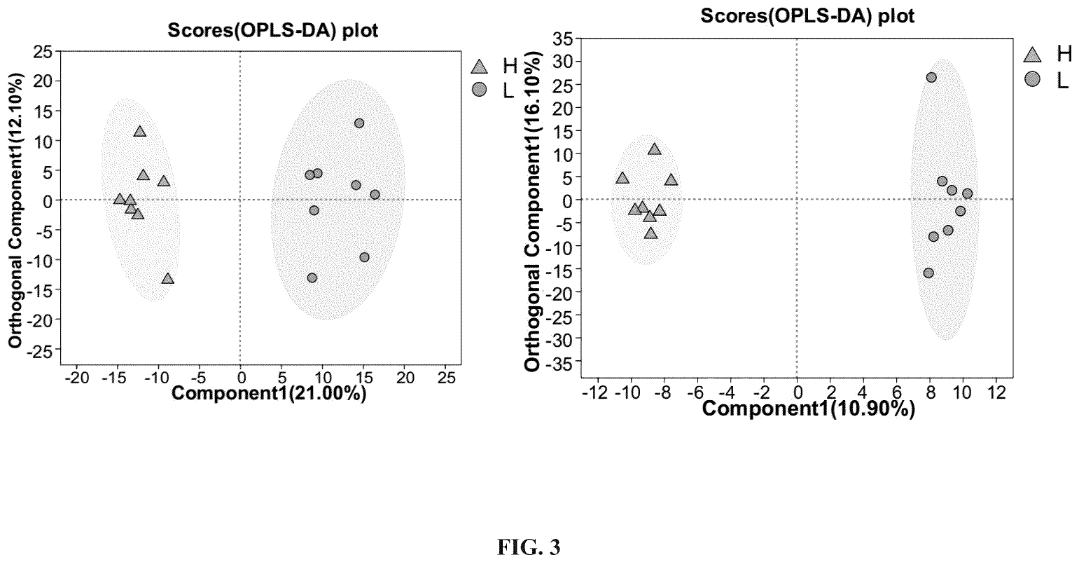

The R software package ropls (Version1.6.2) is used to perform the OPLS-DA modeling analysis on the metabolome data of plasma samples, and the quality of the model is tested by 7-fold cross validation. Through an orthogonal rotation, the score scatter plot (FIG. 3) is obtained after filtering out the information unrelated to the grouping. It can be seen that the difference between the two groups of samples is very significant, and the samples are within the 95% confidence interval. In the two models, R²X is 0.332 and 0.358 respectively, and R²Y (the interpretation rate of the model to the Y matrix) is 0.956 and 0.992 respectively. Q² (the predictive ability of the model) is 0.641 and 0.445, respectively. Generally speaking, the model is more reliable when R² and Q² are closer to 1, the model is better when R² and Q² are higher than 0.5 is better, and the model is acceptable when R² and Q² are higher than 0.3. Therefore, this model is reliable. The samples of HRFI group and LRFI group are obviously clustered into two categories, and the separation is better on the principal component coordinate axis, which indicates that there are significant differences between the two groups in plasma samples.

### \textcircled{3} Replacement Test

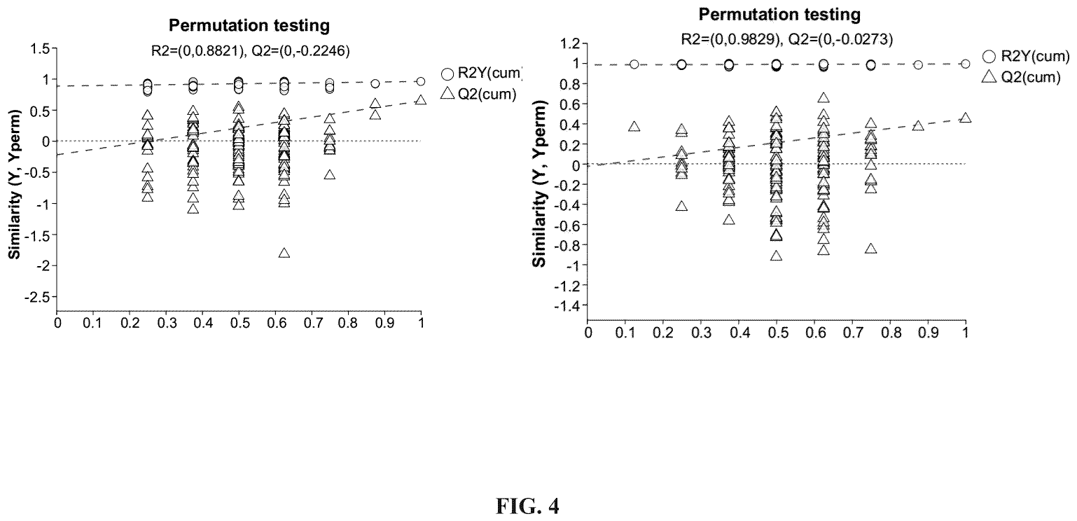

In order to verify the reliability of the OPLS-DA data model and prevent over-fitting, we conducted 200 general choice random permutation tests on the model. In general, when the intercept between the Q² regression line and the Y axis is less than 0.05, it can be considered that the model is robust and reliable, and no fitting occurs. In the positive and negative ion modes, the intercepts of the Q2 regression line and the Y axis are −0.2246 and −0.0273, respectively, indicating that the model has passed the permutation test and there is no over-fitting phenomenon, and the model is reliable (FIG. 4).

### \textcircled{4} Screening of Differential Metabolites Between the High Residual Feed Intake and Low Residual Feed Intake

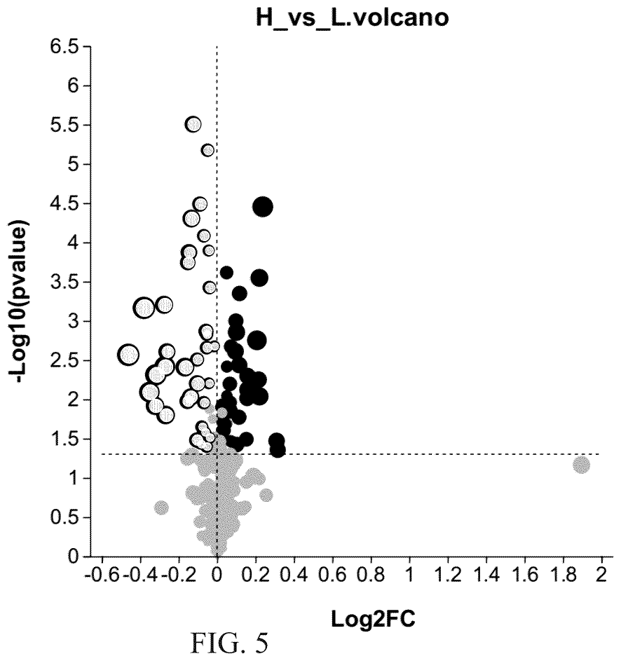

Under the condition that the VIP value of the first principal component of the OPLS-DA model is >1 and P<0.05, 75 differential metabolites are annotated and identified. In the positive and negative ion modes, there are 38 and 37 differential metabolites, respectively (FIG. 5). The red dots represent the significantly down-regulated differential metabolites, the blue dots represent the significantly up-regulated differential metabolites, the gray dots represent metabolites with no significant difference, and the scatter size represents the VIP value of the OPLS-DA model. Lipids, organic acids, and phenylketones accounted for 52.54%, 18.640% and 13.56% of the total, respectively.

### \textcircled{5} Cluster Analysis of Differential Metabolites

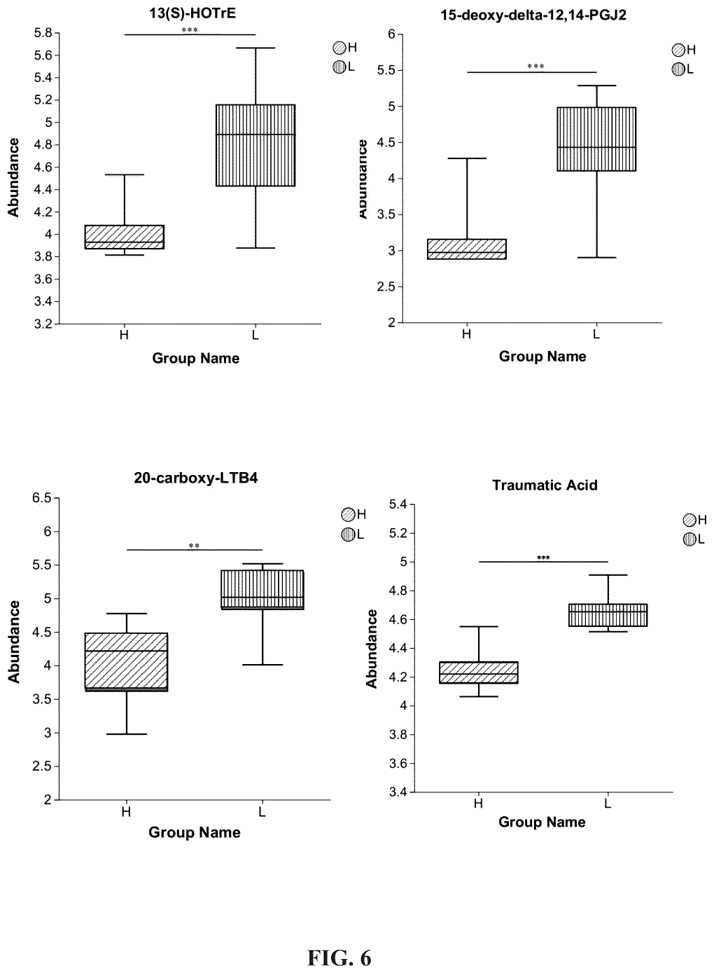

The cluster analysis of differential metabolites is shown in FIG. 6, 8 samples of each group are clustered together and showed a relatively consistent abundance. Compared with the low residual feed intake group, 37 differential metabolites are low in the high residual feed intake group, including lipids, organic acids and their derivatives, nitrogen-containing compounds, etc.; there are 38 differential metabolites with high content in the high residual feed intake group, including lipids, phenylketones, organic acids, and their derivatives.

### \textcircled{6} KEGG Analysis and Metabolic Pathway Enrichment Analysis of Differential Metabolites of Residual Feed Intake

The KEGG pathway enrichment analysis is performed on the significantly differential metabolites, and a total of 19 metabolic pathways are enriched, where 7 metabolic pathways are significantly enriched pathways, the down-regulated metabolites lysophosphatidylcholine (20:2(11Z,14Z))(LysoPC(20:2(11Z,14Z))), Phosphorycholine, Sphingosine, Spermidine, malic acid and D-4′-Phosphopantothenate are significantly enriched in two pathways of arachidonic acid and α-linolenic acid metabolism; the up-regulated metabolites 13-(S)-hydroxyoctadecadienoic acid (13(S)-HOTrE), 15-deoxy-delta-12,14-prostaglandin J2 (15-deoxy-delta-12,14-PGJ2), 20-carboxy-LTB4 (20-carboxy-LTB4) and Traumatic acid are significantly enriched in 5 pathways of β-alanine metabolism, glycerophospholipid metabolism, apoptosis, programmed cell necrosis and citric acid cycle (TCA cycle) (Table 1).

The feed efficiency of low residual feed intake is higher, so it is used as the main object of elaboration; the words ‘down-regulated expression’ and ‘up-regulated expression’ are defined when comparing the low residual feed intake group to the high residual feed intake group.

TABLE 1
KEGG enrichment analysis

| | Pathway Description | KEGG Pathway ID | Metabolite name | P value |
|---|---|---|---|---|
| Down- | Apoptosis | map04210 | Sphingosine | 0.0091 |
| regulated | Necroptosis | map04217 | Sphingosine | 0.0227 |
| enriched | Pyruvate metabolism | map00620 | Malic acid | 0.0689 |
| pathway | Sphingolipid metabolism | map00600 | Sphingosine | 0.0559 |
| | Pantothenate and CoA | map00770 | D-4′- | 0.0624 |
| | biosynthesis | | Phosphopantothenate | |
| | Alanine, aspartate and | map00250 | N-acetylaspartate | 0.0624 |
| | glutamate metabolism | | | |
| | Glutathione metabolism | map00480 | Spermidine | 0.0839 |
| | Citrate cycle (TCA cycle) | map00020 | Malic acid | 0.045 |
| | Arginine biosynthesis | map00220 | N-Acetyl-L-glutamic | 0.0515 |
| | | | acid | |
| | Butanoate metabolism | map00650 | Maleic acid | 0.0923 |
| | Nicotinate and | map00760 | Maleic acid | 0.1193 |
| | nicotinamide metabolism | | | |
| | Glyoxylate and | map00630 | Malic acid | 0.1336 |
| | dicarboxylate metabolism | | | |
| | Arginine and proline | map00330 | Spermidine | 0.1654 |
| | metabolism | | | |
| | Tyrosine metabolism | map00350 | Maleic acid | 0.1654 |
| | ABC transporters | map02010 | Spermidine | 0.2738 |
| | Glycerophospholipid | map00564 | LysoPC(20:2(11Z, 14Z)), | 0.0058 |
| | metabolism | | Phosphocholine | |
| | beta-Alanine metabolism | map00410 | Spermidine, | 0.0022 |
| | | | D-4'- | |
| | | | Phosphopantothenate | |
| Up- | alpha-Linolenic acid | map00592 | 13(S)-HOTrE, | 0.0007 |
| regulated | metabolism | | Traumatic acid | |
| enriched | Arachidonic acid | map00590 | carboxy-LTB4, | 0.0021 |
| pathway | metabolism | | 15-deoxy-delta-12, 14- | |
| | | | PGJ2 | |

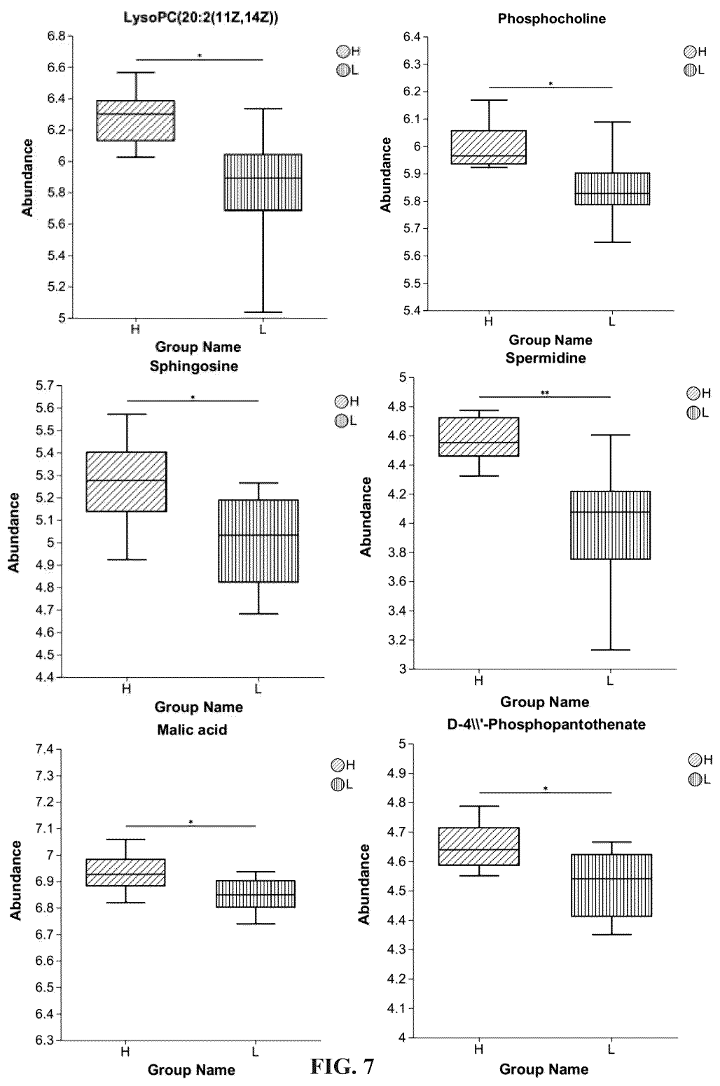

The abundance of significantly enriched pathway-related metabolites in the high and low residual feed intake groups is shown in FIG. 6 and FIG. 7.

### \textcircled{7} ‘Gene-Enzyme-Reaction-Metabolite’ Network Analysis of Significantly Different Lipid Metabolites

The fold change and P value of all significantly differential metabolites are input into the MetScape plug-in of CytoScape (http://metscape.ncibi.org/) to obtain the total network of ‘gene-enzyme-biochemical reaction-metabolite’ and all sub-networks involved in significantly differential metabolites.

### \textcircled{8} Confirmation of Biomarkers for Residual Feed Intake Identification

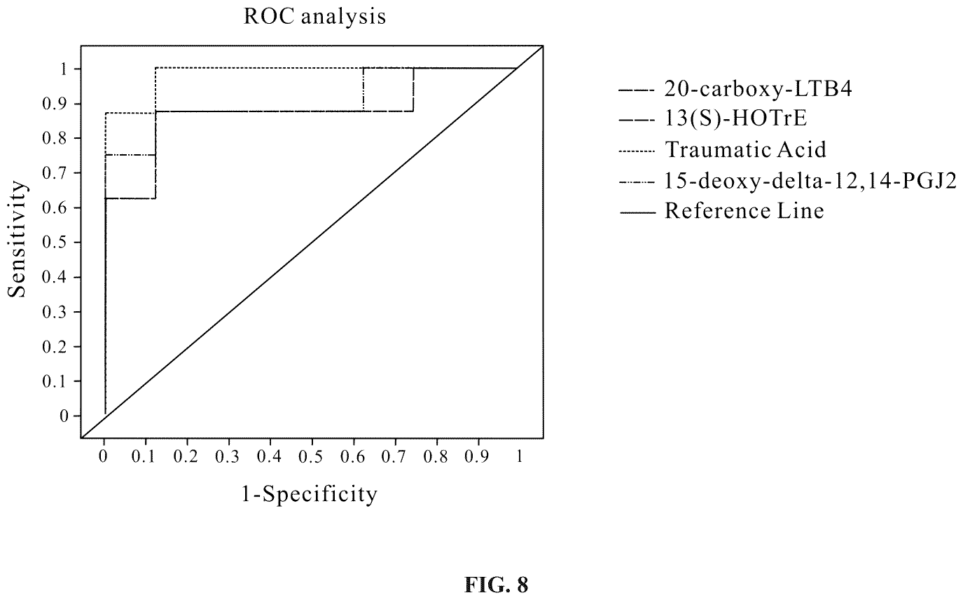

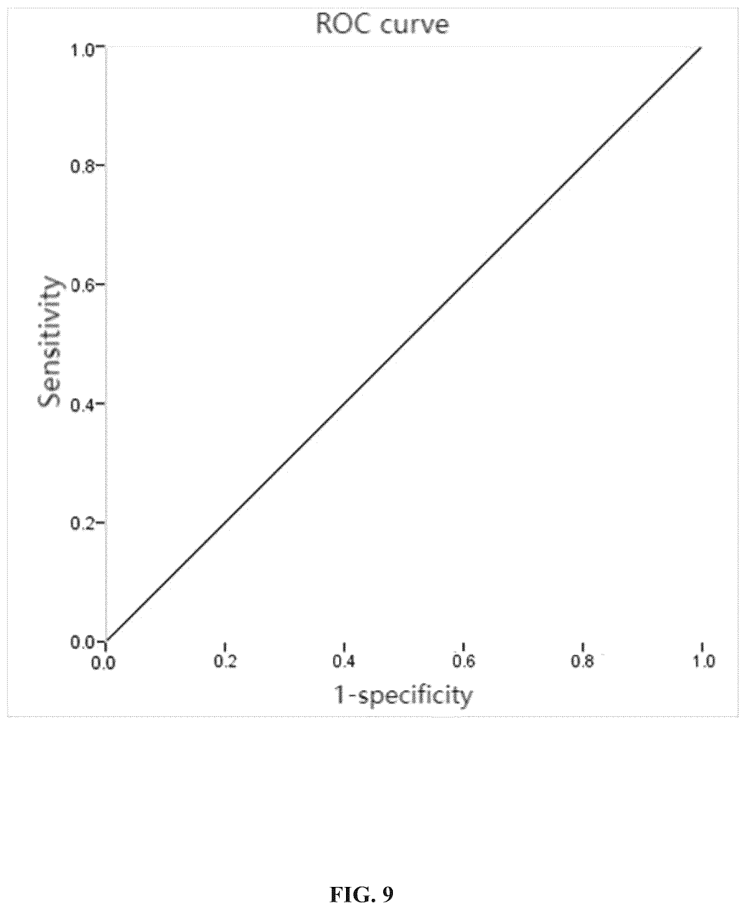

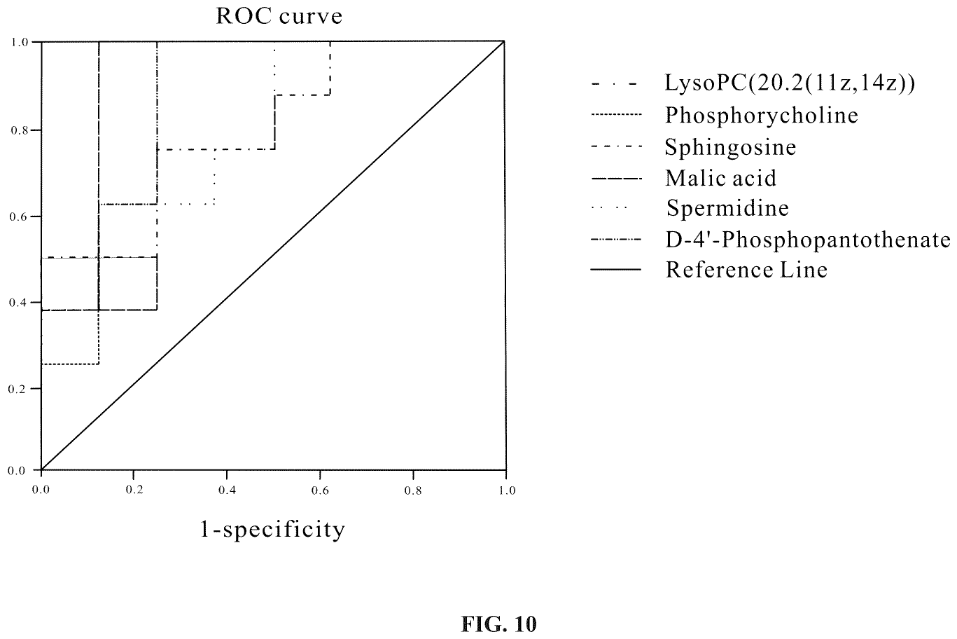

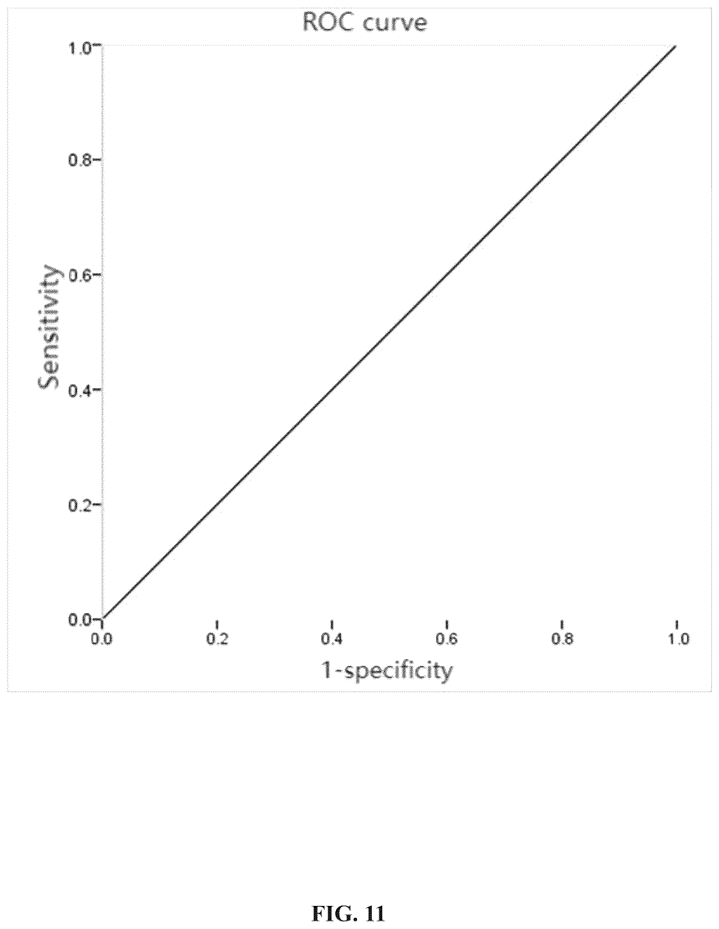

Based on the results of differential metabolite screening and metabolic pathway analysis, the candidate biomarkers related to residual feed intake of chickens in growing period are obtained. The ROC curves of single index and multiple indexes of the candidate plasma differential biomarkers screened in this study are drawn by IBM SPSS Statistics 23 software, and the sensitivity and specificity are calculated, the diagnostic efficacy of the combined action of multiple indexes is analyzed to confirm the biomarkers related to the residual feed intake of chickens in the growing period. The sensitivity, specificity, and AUC of up-regulated biomarkers, down-regulated biomarkers, and biomarker combinations are shown in Table 2 and Table 3, the ROC curves are shown in FIG. 8, FIG. 9, FIG. 10, and FIG. 11.

The ROC curves of differential metabolites in the two groups are plotted by using SPSS software. The ROC curve is a curve that reflects the relationship between sensitivity and specificity, the X-axis of the abscissa is 1-specificity, also known as false positive rate (false alarm rate), when the X-axis is closer to zero, the accuracy rate is higher. The Y-axis of the ordinate is sensitivity, also known as true positive rate (sensitivity), when the value of the Y-axis is larger, the accuracy is better. Sensitivity refers to the proportion that the screening method can correctly determine the actual down-regulated metabolites as the down-regulated metabolites. Specificity means that the screening method can correctly determine the proportion of the actual up-regulated metabolites as the down-regulated metabolites.

The Youden index, also known as the correct index, is an index used to determine the authenticity of a screening test when the dangers of false negatives (missed diagnosis rates) and false positives (misdiagnosis rates) are assumed to be of equal significance. Youden index=sensitivity+specificity−1, when the Youden index is greater, the authenticity is greater and the diagnostic method is better.

The results show that the AUC values of the four up-regulated differential metabolites are larger than 0.875 (Range: 0.875-0.984), the sensitivities are larger than 87.5% (range: 87.5-100%), and the specificities are larger than 87.5% (range: 87.5-100.0%) (Table 2 and FIG. 8). Subsequent combination analysis finds that the AUC value of the combination of 4 up-regulated metabolites is 1.000, the sensitivity is 100.0%, and the specificity is 100.0% (FIG. 9).

TABLE 2
Up-regulated differential metabolites

| Name of | AUC | Sensitivity | Specificity | Youden |
|---|---|---|---|---|
| metabolite | (95% CI) | (%) | (%) | index (%) |
| 13(S)-HOTrE | 0.875 | 87.5 | 87.5 | 75.0 |
| | (0.685-1.000) | | | |
| 15-deoxy- | 0.891 | 87.5 | 87.5 | 75.0 |
| delta-12, | (0.721-1.000) | | | |
| 14-PGJ2 | | | | |
| 20-carboxy- | 0.906 | 87.5 | 87.5 | 75.0 |
| LTB4 | (0.746-1.000) | | | |
| Traumatic | 0.984 | 87.5 | 100.0 | 87.5 |
| acid | (0.936-1.000) | | | |
| Combination | 1.000 | 100.0 | 100.0 | 100.0 |

The ROC results of 6 down-regulated differential metabolites are shown in Table 3 and FIG. 10. The AUC values of 6 down-regulated differential metabolites are larger than 0.766 (range: 0.766-0.922), the sensitivities are larger than 62.5% (range: 62.5-100%), the specificities are larger than 50.0% (range: 50.0-87.5%) (see Table 3 and FIG. 10). Subsequent combination analysis finds that the AUC of the combination of six down-regulated metabolites is 1.000, the sensitivity is 100.0%, and the specificity is 100.0% (see Table 3 and FIG. 11).

TABLE 3
Down-regulated differential metabolites

| | | | | Youden |
|---|---|---|---|---|
| | AUC | Sensitivity | Specificity | index |
| Name of metabolite | (95% CI) | (%) | (%) | (%) |
| Malic acid | 0.766 | 100.0 | 50.0 | 50.0 |
| | (0.528-1.000) | | | |
| D-4′- | 0.797 | 62.5 | 87.5 | 50.0 |
| Phosphopantothenate | (0.576-1.000) | | | |
| LysoPC | 0.875 | 100.0 | 75.0 | 75.0 |
| (20:2(11Z,14Z)) | (0.694-1.000) | | | |
| Phosphorycholine | 0.859 | 100.0 | 75.0 | 75.0 |
| | (0.660-1.000) | | | |
| Sphingosine | 0.797 | 75.0 | 75.0 | 50.0 |
| | (0.576-1.000) | | | |
| Spermidine | 0.922 | 100.0 | 87.5 | 87.5 |
| | (0.768-1.000) | | | |
| Combination | 1.000 | 100.0 | 100.0 | 100.0 |

It is found that a single biomarker does not have a good performance in identifying high and low residual feed intake, and the combination of up-regulated differential metabolites and down-regulated differential metabolites is confirmed as a biomarker to distinguish high and low residual feed intake. According to the comparison of the sensitivity and specificity of the two metabolite combinations in the plasma of the high and low residual feed intake groups, it can be seen that the two combinations have good feasibility and can be used to assist in the identification or detection of the residual feed intake of the chickens in growing period. It can be distinguished according to the amount of two marker combinations in the metabolomics results.

The above is only the preferred embodiment of this application, which is not used to limit this application. For technicians in this field, this application can be subject to various changes and amends. Any modification, equivalent replacement, improvement, etc. made within the spirit and principles of this application shall be included in the scope of protection of this application.

What is claimed is:

1. Biomarkers associated with residual feed intake of chickens in growing period, comprising one or multiple components of 13-(S)-hydroxyoctatrienoic acid (13(S)-HOTrE), 20-carboxy-leukotriene B4 (20-carboxy-LTB4), Traumatic acid, 15-deoxy-delta-12,14-prostaglandin J2 (15-deoxy-delta-12,14-PGJ2), lysophosphatidylcholine (20:2(11Z,14Z)) (LysoPC(20:2(11Z,14Z))), phosphorycholine, Sphingosine, malic acid, D-4′-Phosphopantothenate, and Spermidine.

2. The biomarkers according to claim 1, wherein the biomarkers comprise an up-regulated marker combination and a down-regulated marker combination;
the up-regulated marker combination is composed of 13(S)-HOTrE, 20-carboxy-LTB4, Traumatic acid and 15-deoxy-delta-12, 14-PGJ2; and
the down-regulated marker combination is composed of LysoPC(20:2(11Z,14Z)), phosphorycholine, malic acid, D-4′-Phosphopantothenate, Sphingosine and Spermidine.

3. An usage of the biomarkers according to claim 1 in a preparation of reagents or kits for identifying the residual feed intake of chickens in growing period.

4. The usage according to claim 3, the kits comprise a reagent combination for detecting the biomarkers.

5. The usage according to claim 4, the reagent combination includes a substance for detecting the biomarkers by mass spectrometry.

6. An application of the biomarkers according to claim 1 as a target in a selective breeding of chickens with low residual feed intake.

7. A selective breeding method for chickens with low residual feed intake, the method comprises steps of detecting biomarkers in chicken serum by mass spectrometry.

8. The method according to claim 7, wherein the biomarkers comprise an up-regulated marker combination and a down-regulated marker combination;
the up-regulated marker combination is composed of 13(S)-HOTrE, 20-carboxy-LTB4, Traumatic acid and 15-deoxy-delta-12,14-PGJ2; and
the down-regulated marker combination is composed of LysoPC(20:2(11Z,14Z)), phosphorycholine, malic acid, D-4′-Phosphopantothenate, Sphingosine and Spermidine.

9. An usage of the biomarkers according to claim 2 in a preparation of reagents or kits for identifying the residual feed intake of chickens in growing period.

10. An application of the biomarkers according to claim 2 as a target in a selective breeding of chickens with low residual feed intake.
